(19) United States
(12) Patent Application Publication
(10) Pub. No.: US 2011/0171513 A1
(43) Pub. Date: Jul. 14, 2011

(54) SODIUM SECONDARY BATTERY

(75) Inventors: Satoru Kuze, Ibaraki (JP); Yutaka Suzuki, Ibaraki (JP); Keiji Ono, Osaka (JP)

(73) Assignee: SUMITOMO CHEMICAL COMPANY, LIMITED, Tokyo (JP)

(21) Appl. No.: 13/001,235

(22) PCT Filed: Jun. 29, 2009
(86) PCT No.: PCT/JP2009/062240

§ 371 Date: Dec. 23, 2010

(30) Foreign Application Priority Data
Jun. 30, 2008 (JP) 2008-170239

(51) Int. Cl. H01M 2/16; H01M 4/583

(52) U.S. Cl. 429/144

(57) ABSTRACT

The present invention provides a sodium secondary battery. The sodium secondary battery includes a positive electrode, a negative electrode, a separator disposed between the positive electrode and the negative electrode, and a nonaqueous electrolytic solution, the separator is composed of a porous laminate film in which a heat resistant porous layer and a porous film are stacked each other, and the heat resistant porous layer is disposed on the negative electrode side.

### TECHNICAL FIELD

The present invention relates to a sodium secondary battery.

### BACKGROUND ART

A secondary battery usually has a positive electrode, a negative electrode, and a separator composed of a porous film that is disposed between the positive electrode and the negative electrode. When an extraordinary current flows in the battery due to a short circuit between the positive and negative electrodes, or the like, it is important for the secondary battery to block the current and then to prevent an excessive current from flowing (to shutdown). Therefore, the separator is required to perform the shutdown (obstruct micropores of the porous film) when a usual use temperature is exceeded. Even when the temperature in the battery is increased to a certain high temperature after the shutdown, the separator is required to maintain the shutdown state without causing film rupture due to the increase in temperature, in other words, the separator is required to have high heat resistance.

On the other hand, a lithium secondary battery is a representative example of the secondary battery, and has already been put into commercial use as a small power source for cellular phones, laptop computers and the like. Further, since the lithium secondary battery is usable as a large power source, for example, as a power source for automobiles such as electric automobiles and hybrid electric automobiles, or as a power source for distributed power storages, the demand therefor is on the rise. However, in the lithium secondary battery, a large amount of scarce metal elements such as lithium and the like is contained in a mixed metal oxide constituting its positive electrode, and there is concern about supply of the material to meet the growing demand for a large power source.

In response, a sodium secondary battery is being studied as a secondary battery capable of eliminating the concern about supply. The sodium secondary battery can be fabricated using a material which has a plentiful supply and which is inexpensive, and its commercial application is expected to allow for a large supply of large power sources.

As the sodium secondary battery, for example, JP03-291863A (Example 1) discloses a sodium secondary battery in which Na_{0.7}Ni_{0.3}Co_{0.7}O₂ is used as a positive electrode, a sodium-lead alloy is used as a negative electrode, and a polypropylene microporous film is used as a separator.

### DISCLOSURE OF THE INVENTION

However, it can not be said that conventional sodium secondary batteries should be appropriate from the perspective of heat resistance. The secondary batteries also have various problems in view of secondary battery properties. An object of the present invention is to provide a sodium secondary battery superior in heat resistance and also superior in secondary battery properties such as a discharge capacity maintenance ratio and the like as compared with conventional secondary batteries.

The present inventors have conducted various studies, and the present invention has been accomplished as the result of the studies.

That is, the present invention provides the following.

<1> A sodium secondary battery comprising a positive electrode, a negative electrode, a separator disposed between the positive electrode and the negative electrode, and a nonaqueous electrolytic solution, wherein the separator is composed of a porous laminate film in which a heat resistant porous layer and a porous film are stacked each other, and the heat resistant porous layer is disposed on a negative electrode side.

<2> The sodium secondary battery according to <1>, wherein the heat resistant porous layer contains a heat resistant resin.

<3> The sodium secondary battery according to <2>, wherein the heat resistant resin is a nitrogen-containing aromatic polymer.

<4> The sodium secondary battery according to <2> or <3>, wherein the heat resistant resin is an aromatic polyamide.

<5> The sodium secondary battery according to any one of <2> to <4>, wherein the heat resistant porous layer further contains a filler.

<6> The sodium secondary battery according to <5>, wherein an amount of the filler is 20 parts by weight or more and 95 parts by weight or less when a total weight of the heat resistant porous layer is assumed to be 100 parts by weight.

<7> The sodium secondary battery according to <5> or <6>, wherein the heat resistant porous layer contains two or more types of the fillers and, a ratio of D₂/D₁ is 0.15 or less where the largest average particle diameter is D₁ and the second largest average particle diameter is D₂ among average particle diameters each of which is determined by measuring constituent particles in each of the fillers.

<8> The sodium secondary battery according to any one of <1> to <7>, wherein the thickness of the heat resistant porous layer is 1 μm or more and 10 μm or less.

<9> The sodium secondary battery according to any one of <1> to <8>, wherein the negative electrode contains a carbonaceous material capable of being doped and dedoped with sodium ions.

<10> The sodium secondary battery according to <9>, wherein the carbonaceous material is a hardly graphitizable carbonaceous material.

<11> The sodium secondary battery according to any one of <1> to <10>, wherein the porous film contains a polyolefin resin.

### MODE FOR CARRYING OUT THE INVENTION

### Sodium Secondary Battery

A sodium secondary battery according to the present invention includes a positive electrode, a negative electrode, a separator disposed between the positive electrode and the negative electrode, and a nonaqueous electrolytic solution, the separator is composed of a porous laminate film in which a heat resistant porous layer and a porous film are stacked each other, and the heat resistant porous layer is disposed on the negative electrode side. With this structure, it is possible for the sodium secondary battery to significantly improve heat resistance, and to enhance also secondary battery properties such as a discharge capacity maintenance ratio and the like. In terms of uses in automobiles such as electric automobiles, and hybrid electric automobiles, it is possible to obtain a sodium secondary battery in which higher output at a high current rate can be provided due to suppressing local deposition of a minute sodium metal at the interface between a negative electrode and a heat resistant porous layer while rapid charging and discharging, i.e., a sodium secondary battery superior in rate property. In addition, even when the local generation of the sodium metal is repeated and the minute sodium metal grows into a dendrite to increase the possibility of occurrence of a short circuit between positive and negative electrodes and induce the heating of a nonaqueous electrolytic solution, the dendrite tends to be dissolved by the heating so that it is possible to obtain a sodium secondary battery superior also in cycle property when charge and discharge are repeated.

### Separator

A separator is composed of a porous laminate film in which a heat resistant porous layer and a porous film are stacked each other. In the porous laminate film, the heat resistant porous layer is a layer having heat resistance higher than that of the porous film, and the heat resistant porous layer may be formed from an inorganic powder, and may contain a heat resistant resin. With the heat resistant porous layer containing the heat resistant resin, the heat resistant porous layer can be formed by an easy method such as coating. Examples of the heat resistant resin include polyimide, polyimide, polyamideimide, polycarbonate, polyacetal, polysulfone, polyphenylene sulfide, polyether ketone, aromatic polyester, polyether sulfone, and polyether imide. From the standpoint of further enhancing the heat resistance, preferable are polyamide, polyimide, polyamideimide, polyether sulfone, and polyether imide, and more preferable are polyamide, polyimide, and polyamideimide. Further more preferable are nitrogen-containing aromatic polymers such as aromatic polyamide (para-oriented aromatic polyamide, meta-oriented aromatic polyamide), aromatic polyimide, and aromatic polyamideimide, particularly preferable is aromatic polyamide and, from the standpoint of production, especially preferable is para-oriented aromatic polyamide (hereinafter, referred to as “para-aramide” in some cases). In addition, examples of the heat resistant resin also include poly-4-methylpentene-1 and cyclic olefin polymers.

By using such a heat resistant resin, the heat resistance can be enhanced, i.e., thermal film rupture temperature can be increased. Among these heat resistant resins, when the nitrogen-containing aromatic polymers are used, probably due to polarity in molecules thereof, compatibility with the nonaqueous electrolytic solution, i.e., a liquid retention property in the heat resistant porous layer is significantly improved, which causes the higher impregnation rate of the nonaqueous electrolytic solution during the production of the sodium secondary battery, and increasing the contact area between the negative electrode and the nonaqueous electrolytic solution, and the charge and discharge capacity of the sodium secondary battery can also be further enhanced. In addition, the nitrogen-containing aromatic polymer captures the minute sodium metal that can be locally generated, and the growth into the dendrite can be thereby suppressed. Further, in this case, it is possible to facilitate the formation of a solid layer on the surface of the negative electrode on the basis of decomposition of the electrolytic solution between the negative electrode and the heat resistant porous layer so that it is possible to further reduce irreversible capacity in the sodium secondary battery.

The thermal film rupture temperature depends on the types of heat resistant resin. By using the above-described nitrogen-containing aromatic polymers as the heat resistant resin, the thermal film rupture temperature can be increased up to about 400° C. at the maximum. When poly-4-methylpentene-1 is used, the thermal film rupture temperature can be increased up to about 250° C. at the maximum and, when cyclic olefin polymers are used, the thermal film rupture temperature can be increased up to about 300° C. at the maximum. Further, when the heat resistant resin is composed of an inorganic powder, the thermal film rupture temperature can be increased up to, e.g., 500° C. or more.

The para-aramide is obtained by condensation polymerization of a para-oriented aromatic diamine and a para-oriented aromatic dicarboxylic halide, and consists substantially of a repeating unit in which an amide bond is linked at a para-position or equivalently oriented position of the aromatic ring (for example, the oriented position extending coaxially or in parallel to the opposite direction, such as 4,4′-biphenylene, 1,5-naphthalene, and 2,6-naphthalene). Specific examples thereof include a para-aramide having a para-oriented-type structure and a quasi-para-oriented-type such as poly(para-phenyleneterephthalamide), poly(para-benzamide), poly(4,4′-benzanilide terephthalamide), poly(para-phenylene-4,4′-biphenylene dicarboxylic amide), poly(para-phenylene-2,6-naphthalene dicarboxylic amide), poly(2-chloro-para-phenyleneterephthalamide), and para-phenyleneterephthalamide/2,6-dichloro para-phenyleneterephthalamide copolymer.

The aromatic polyimide is preferably a wholly aromatic polyimide produced by condensation polymerization of an aromatic diacid anhydride and a diamine. Specific examples of the diacid anhydride include pyromellitic dianhydride, 3,3′,4,4′-diphenylsulfone tetracarboxylic dianhydride, 3,3′,4,4′-benzophenone tetracarboxylic dianhydride, 2,2′-bis(3,4-dicarboxyphenyl)hexafluoropropane, and 3,3′,4,4′-biphenyl tetracarboxylic dianhydride. Specific examples of the diamine include oxydianiline, para-phenylenediamine, benzophenonediamine, 3,3′-methylenedianiline, 3,3′-diaminobenzophenone, 3,3′-diaminodiphenylsulfone, and 1,5′-naphthalenediamine. A polyimide soluble in a solvent may be suitably used. Examples of such a polyimide include a polyimide as a polycondensate of 3,3′,4,4′-diphenylsulfone tetracarboxylic dianhydride with an aromatic diamine.

Examples of the aromatic polyamideimide include those obtained by condensation polymerization of an aromatic dicarboxylic acid and an aromatic diisocyanate, and those obtained by condensation polymerization of an aromatic diacid anhydride and an aromatic diisocyanate. Specific examples of the aromatic dicarboxylic acid include isophthalic acid, and terephthalic acid. Specific examples of the aromatic dianhydride include trimellitic anhydride. Specific examples of the aromatic diisocyanate include 4,4′-diphenylmethane diisocyanate, 2,4-tolylene diisocyanate, 2,6-tolylene diisocyanate, ortho-tolylane diisocyanate, and m-xylene diisocyanate.

In order to enhance sodium ion permeability, the thickness of the heat resistant porous layer is preferably 1 μm or more and 10 μm or less, further preferably 1 μm or more and 5 μm or less, and particularly preferably 1 μm or more and 4 μm or less. The heat resistant porous layer has micropores, and the pore size (diameter) is usually 3 μm or less, and preferably 1 μm or less.

When the heat resistant porous layer contains the heat resistant resin, the heat resistant porous layer may further include a filler. The material of the filler may be any one selected from an organic powder, an inorganic powder, and a mixture thereof. The average particle diameter of particles constituting the filler is preferably 0.01 μm or more and 1 μm or less.

Examples of the organic powder include powders made of organic substances, such as a homopolymer of or a copolymer of two or more kinds of styrene, vinyl ketone, acrylonitrile, methyl methacrylate, ethyl methacrylate, glycidyl methacrylate, glycidyl acrylate, and methyl acrylate; fluorine-containing resins, such as polytetrafluoroethylene, ethylene tetrafluoride-propylene hexafluoride copolymer, ethylene tetrafluoride-ethylene copolymer, and polyvinylidene fluoride; melamine resins; urea resins; polyolefins; and polymethacrylate. The organic powders may be used singly, or in admixture of two or more. Among the organic powders, a polytetrafluoroethylene powder is preferable in view of chemical stability.

Examples of the inorganic powder include powders made of inorganic substances such as metal oxides, metal nitrides, metal carbides, metal hydroxides, carbonates, and sulfates, and of them, powders made of inorganic substances having low electric conductivity are preferably used. Specific examples thereof include powders made of alumina, silica, titanium dioxide, or calcium carbonate. The inorganic powders may be used singly or in admixture of two or more. Among these inorganic powders, an alumina powder is preferable in terms of chemical stability. It is more preferable that all particles constituting the filler be alumina particles, and further more preferable is an embodiment in which all particles constituting the filler are alumina particles and a part or all of them are approximately spherical alumina particles. When the heat resistant porous layer is formed from the inorganic powder, the above-exemplified inorganic powders may be advantageously used, and they may be used in admixture with a binder on an as needed basis.

When the heat resistant porous layer contains the heat resistant resin, the content of the filler varies depending on the specific gravity of the material of the filler. For example, the amount of the filler is usually 5 parts by weight or more and 95 parts by weight or less, preferably 20 parts by weight or more and 95 parts by weight or less, and more preferably 30 parts by weight or more and 90 parts by weight or less, assuming that the total weight of the heat resistant porous layer is 100 parts by weight. These ranges are particularly suitable when all particles constituting the filler are alumina particles.

Examples of the shape of the filler include an approximately spherical shape, plate shape, column shape, needle shape, whisker shape, and fiber shape, and any particles of these shapes may be used. The approximately spherical particles are preferable because of easiness in forming uniform pores. Examples of the approximately spherical particles include particles having an aspect ratio (longer diameter of particle/shorter diameter of particle) within a range of 1 or more and 1.5 or less. The aspect ratio of particles can be determined using an electron micrograph.

As described above, the heat resistant porous layer can also contain two or more types of fillers. In this case, the value of D₂/D₁ is preferably 0.15 or less where the largest average particle diameter is D₁ and the second largest average particle diameter is D₂ among average particle diameters each of which is determined by measuring constituent particles in each of the fillers. With this, in the micropores of the heat resistant porous layer of the porous laminate film, a proper balance of relatively small-sized micropores and relatively large-sized micropores is offered. The heat resistance of the separator composed of the porous laminate film can be enhanced due to the structure of the relatively small-sized micropores, the sodium ion permeability can be enhanced due to the structure of the relatively large-sized micropores, and the sodium secondary battery to be obtained can provide higher output at a high current rate, i.e., the sodium secondary battery has much superior rate property, and is therefore suitable. Values measured from the electron micrograph may be appropriately used as the average particle diameters. That is, when particles (filler particles) in a scanning electron micrograph of a surface or a cross section of the heat resistant porous layer in the porous laminate film are classified according to sizes and, among values of average particle diameters of individual classifications, the largest diameter is assumed to be D₁ and the second largest diameter is assumed to be D₂, the value of D₂/D₁ may appropriately be 0.15 or less. The average particle diameter is determined by arbitrarily extracting 25 particles in each of the classifications described above, measuring particle sizes (diameter) of the individual particles, and then calculating the average value of particle diameters of the 25 particles. It is to be noted that the above-described particles constituting the filler mean primary particles constituting the filler.

In the porous laminate film, the porous film has micropores, and usually has a shutdown function. The size (diameter) of the micropores in the porous film is usually 3 μm or less, and preferably 1 μm or less. The porous film has a porosity of usually 30 to 80% by volume, and preferably 40 to 70% by volume. In the sodium secondary battery, when a usual use temperature is exceeded, the micropores can be obstructed by deformation and softening of the porous film due to the shutdown function.

A resin constituting the porous film may be advantageously selected from among resins that are not dissolved in the nonaqueous electrolytic solution in the sodium secondary battery. Specific examples thereof include polyolefin resins such as polyethylene, and polypropylene, and thermoplastic polyurethane resins, and a mixture of two or more of these may also be used. For softening at a lower temperature to perform the shutdown, the porous film preferably contains polyolefin resins, and more preferably contains polyethylene. Specific examples of the polyethylene include polyethylenes such as low density polyethylene, high density polyethylene, and linear polyethylene, and ultrahigh molecular weight polyethylenes are also included. For further enhancing the puncture strength of the porous film, the resin constituting the porous film preferably contains at least the ultrahigh molecular weight polyethylene. From the standpoint of production of the porous film, it is preferable in some cases that a wax composed of a polyolefin having a low molecular weight (weight average molecular weight of 10000 or less) be contained.

The thickness of the porous film is usually 3 to 30 μm, and further preferably 3 to 20 μm. The thickness of the porous laminate film is usually 40 μm or less, and preferably 20 μm or less. When the thickness of the heat resistant porous layer is assumed to be A (μm) and the thickness of the porous film is assumed to be B (μm), the value of A/B is preferably 0.1 and more and 1 or less.

Considering the ion permeability, the air permeability of the porous laminate film, in terms of the Gurley method, preferably 50 to 300 sec/100 cc, and further preferably 50 to 200 sec/100 cc. The porous laminate film has a porosity of usually 30 to 80% by volume, and preferably 40 to 70% by volume.

Next, a description will be given of an example of production for the porous laminate film.

First, a method of producing the porous film will be described. The production of the porous film is not particularly limited, and examples of the production method include a method in which film molding is carried out by adding a plasticizer to a thermoplastic resin and the plasticizer is then removed using a suitable solvent, as described in JP07-29563A, and a method in which a film composed of a thermoplastic resin produced by a known method is used and then an amorphous portion of the film that is structurally weak is selectively drawn to form micropores, as described in JP07-304110A. For example, when the porous film is formed from a polyolefin resin containing an ultrahigh molecular weight polyethylene and a low molecular weight polyolefin having a weight average molecular weight of 10000 or less, it is preferable to produce the porous film by a method shown below in terms of production cost. That is, the method including:

(1) a step of kneading 100 parts by weight of an ultrahigh molecular weight polyethylene, 5 to 200 parts by weight of a low molecular weight polyolefin having a weight, average molecular weight of 10000 or less, and 100 to 400 parts by weight of an inorganic filler to yield a polyolefin resin composition,

(2) a step of molding a sheet using the polyolefin resin composition,

(3) a step of removing the inorganic filler from the sheet yielded in the step (2), and

(4) a step of drawing the sheet yielded in the step (3) to yield the porous film, or a method including:

(1) a step of kneading 100 parts by weight of an ultrahigh molecular weight polyethylene, 5 to 200 parts by weight of a low molecular weight polyolefin having a weight average molecular weight of 10000 or less, and 100 to 400 parts by weight of an inorganic filler to yield a polyolefin resin composition,

(2) a step of molding a sheet using the polyolefin resin composition,

(3) a step of drawing the sheet yielded in the step (2), and

(4) a step of removing the inorganic filler from the drawn sheet yielded in the step (3) to yield the porous film.

In terms of strength and ion permeability of the porous film, the inorganic filler to be used has an average particle size (diameter) of preferably 0.5 μm or less, and further preferably 0.2 μm or less. Herein, the value measured from an electron micrograph is used as the average particle diameter. Specifically, 50 particles are arbitrarily extracted from inorganic filler particles in the micrograph, then particle sizes of the individual particles are measured, and the average value thereof is used as the average particle diameter.

Examples of the inorganic filler include calcium carbonate, magnesium carbonate, barium carbonate, zinc oxide, calcium oxide, aluminum hydroxide, magnesium hydroxide, calcium hydroxide, calcium sulfate, silicic acid, zinc oxide, calcium chloride, sodium chloride, and magnesium sulfate. These inorganic fillers can be removed from a sheet or a film using an acid or alkaline solution. In terms of controllability of particle sizes and selective solubility in acid, it is preferable to use calcium carbonate.

A method of producing the polyolefin resin composition is not particularly limited. Materials constituting the polyolefin resin composition such as a polyolefin resin, and an inorganic filler are mixed using mixers such as a roll, Banbury mixer, single-screw extruder, and twin-screw extruder to yield the polyolefin resin composition. When the materials are mixed, fatty acid esters and additives such as a stabilizing agent, antioxidant, ultraviolet absorber, and flame-retardant may also be added on an as needed basis.

A method of producing the sheet composed of the polyolefin resin composition is not particularly limited, and the sheet can be produced by sheet molding methods such as inflation processing, calendering processing, T-die extrusion processing, and a skife method. Since a sheet having higher film thickness accuracy is obtainable, it is preferable to produce the sheet by the following method.

The preferable method of producing the sheet composed of the polyolefin resin composition is a method in which a polyolefin resin composition is roll-molded by using a pair of rotational molding tools having a surface temperature adjusted to be higher than the melting point of a polyolefin resin contained in the polyolefin resin composition. The surface temperature of the rotational molding tools is preferably (melting point +5)° C. or more. The upper limit of the surface temperature is preferably (melting point +30)° C. or less, and further preferably (melting point +20)° C. or less. Examples of the pair of rotational molding tools include a roll and a belt. The circumferential velocities of both of the rotational molding tools are not necessarily strictly the same circumferential velocity, and it is sufficient as long as the difference between the circumferential velocities thereof is within about ±5%. The porous film is produced by using the sheet obtained by such method, whereby the porous film superior in strength, ion permeability, air permeability, and the like can be obtained. In addition, a sheet obtained by stacking single-layered sheets obtained by the above-described method may be used in the production of the porous film.

When the polyolefin resin composition is roll-molded by the pair of rotational molding tools, a polyolefin resin composition discharged from an extruder in strand form may be introduced directly between the pair of rotational molding tools, and a polyolefin resin composition that has been temporarily formed into pellets may also be used.

When the sheet composed of the polyolefin resin composition or the sheet in which the inorganic filler is removed is drawn, a tenter, roll, autograph or the like can be used. In terms of the air permeability, a draw ratio is preferably 2 to 12 times, and more preferably 4 to 10 times. Drawing is carried out at a drawing temperature of usually not less than the softening point of the polyolefin resin and not more than the melting point thereof, and is preferably carried out at a drawing temperature of 80 to 115° C. When the drawing temperature is too low, film rupture tends to occur during the drawing, while when the drawing temperature is too high, the air permeability and the ion permeability of a resultant film are lowered in some cases. After the drawing is carried out, it is preferable to perform heat setting. A heat setting temperature is preferably lower than the melting point of the polyolefin resin.

The porous film containing the thermoplastic resin obtained by the above-described method and the heat resistant porous layer are stacked each other to yield the porous laminate film. The heat resistant porous layer may be appropriately provided on a surface of the porous film. It is preferable that the heat resistant porous layer be provided on one surface of the porous film, and not provided on the other surface.

Examples of a method of stacking the porous film and the heat resistant porous layer include a method in which the heat resistant porous layer and the porous film are separately produced and then stacked each other, and a method in which a coating liquid containing a heat resistant resin and a filler is applied on the surface of the porous film to form the heat resistant porous layer. When the heat resistant porous layer is relatively thin, the latter method is preferable in terms of productivity. A specific example of the method in which a coating liquid containing a heat resistant resin and a filler is applied on the surface of the porous film to form a heat resistant resin layer includes a method including the following steps.

(a) A slurry-form coating liquid is prepared in which 1 to 1500 parts by weight of a filler with respect to 100 parts by weight of a heat resistant resin is dispersed in a polar organic solvent solution containing 100 parts by weight of the heat resistant resin.

(b) The coating liquid is applied on the surface of the porous film to form a coating membrane.

(c) The heat resistant resin is deposited from the above-described coating membrane by a means such as moistening, solvent removal, or immersion in a solvent that dose not dissolve the heat resistant resin, and is then dried on an as needed basis.

The coating liquid is preferably applied continuously by employing a coating apparatus described in JP2001-316006A and a method described in JP2001-23602A.

When the heat resistant resin in the polar organic solvent solution is the para-aramide, a polar amide solvent or a polar urea solvent can be used as a polar organic solvent. Specific examples thereof include N,N-dimethylformamide, N,N-dimethylacetamide, N-methyl-2-pyrrolidone (NMP), and tetramethylurea. The polar organic solvent is not limited thereto.

In case of using the para-aramide as the heat resistant resin, for the purpose of improving the solubility of the para-aramide in solvent, it is preferable to add chlorides of alkali metals or alkali earth metals when para-aramide polymerization is carried out. Specific examples thereof include lithium chloride and calcium chloride, the chlorides are not limited thereto. The amount of the chloride to be added to the polymerization system is preferably in a range of 0.5 to 6.0 mol per 1.0 mol of an amide group generated by condensation polymerization, and more preferably in a range of 1.0 to 4.0 mol. When the chloride is less than 0.5 mol, the solubility of the para-aramide to be generated is not sufficient in some cases. The case where the chloride is more than 6.0 mol is not preferable in some cases because the solubility of the chloride in the solvent is substantially exceeded. In general, when the chloride of the alkali metal or alkali earth metal is less than 2% by weight, the solubility of the para-aramide is insufficient in some cases and, when the chloride is more than 10% by weight, the chloride of the alkali metal or alkali earth metal is not dissolved in polar organic solvents such as the polar amide solvent, and the polar urea solvent in some cases.

When the heat resistant resin is an aromatic polyimide, as polar organic solvents that dissolve the aromatic polyimide, dimethyl sulfoxide, cresol, o-chlorophenol and the like can be suitably used in addition to those exemplified as solvents that dissolve the aramide.

A method of yielding the slurry-form coating liquid by dispersing the filler includes a method using apparatuses such as pressure dispersion machines (Gaulin homogenizer, nanomizer).

Examples of a method of coating the slurry-form coating liquid include coating methods such as a knife, blade, bar, gravure, and die. Coating methods using the bar, die and the like are simple. The die coating, which has a configuration in which a solution does not come in contact with the air, is preferable from industrial point of view. There are cases where the coating is carried out twice or more. In this case, the coating is usually carried out after the heat resistant resin is deposited in the above-described step (c).

In the above-described case where the heat resistant porous layer and the porous film are separately produced and then stacked, it is advantageous to fix them by methods using an adhesive, thermal fusion, and the like.

In the sodium secondary battery, the above-described porous laminate film can be used as the separator.

### Positive Electrode

A positive electrode is a member in which a positive electrode mixture containing a positive electrode active material, binder, electrical conductive material and the like is supported on a positive electrode current collector, and the positive electrode is usually in the form of a sheet. More specifically, examples of a method of obtaining the positive electrode include a method in which a positive electrode mixture obtained by adding a solvent to a positive electrode active material, binder, electrical conductive material and the like is applied on a positive electrode current collector by a doctor blade method and the like, or immersion, and then dried, a method in which a solvent is added to a positive electrode active material, binder, electrical conductive material and the like, the mixture is kneaded, molded, and dried to yield a sheet, and the sheet is pressed and dried by a thermal treatment after being joined to the surface of a positive electrode current collector via a conductive adhesive or the like, and a method in which a mixture composed of a positive electrode active material, binder, electrical conductive material, liquid lubricant and the like is molded on a positive electrode current collector, the liquid lubricant is then removed, and the resultant sheet-shaped molded article is subjected to a drawing treatment toward a uniaxial or multiaxial direction. When the positive electrode is in the form of a sheet, the thickness thereof is usually about 5 to 500 μm.

The positive electrode active material, which can be used, includes a positive electrode material capable of being doped and dedoped with sodium ions. In terms of a cycle property of the sodium secondary battery to be obtained, it is preferable to use inorganic sodium compounds as the positive electrode material. Examples of the inorganic sodium compounds include the following compounds. That is, examples thereof include oxides represented by NaM¹ₐO₂ such as NaFeO₂, NaMnO₂, NaNiO₂, and NaCoO₂, oxides represented by Na_{0.44}Mn₁₋ₐM¹ₐO₂, oxides represented by Na_{0.7}Mn₁₋ₐM¹ₐO_{2.05} (wherein M¹ represents one or more transition metal elements, 0≦a<1); oxides represented by Na_{b}M²_{c}Si₁₂O₃₀ such as Na₆Fe₂Si₁₂O₃₀, and Na₂Fe₅Si₁₂O₃₀ (wherein M² represents one or more transition metal elements, 2≦b≦6, 2≦c≦5); oxides represented by Na_{d}M³ₑSi₆O₁₈ such as Na₂Fe₂Si₆O₁₈, and Na₂MnFeSi₆O₁₈ (wherein M³ represents one or more transition metal elements, 3≦d≦6, 1≦e≦2); oxides represented by Na_{f}M⁴_{g}Si₂O₆ such as Na₂FeSiO₆ (wherein M⁴ represents one or more elements selected from the group consisting of transition metal elements, Mg, and Al, 1≦f≦5, 1≦g≦2); phosphates such as NaFePO₄, and Na₃Fe₂(PO₄)₃; borates such as NaFeBO₄, and Na₃Fe₂(BO₄)₃; and fluorides represented by NaₕM⁵F₆ such as Na₃FeF₆, and Na₂MnF₆ (wherein M⁵ represents one or more transition metal elements, 2≦h≦3).

Among the inorganic sodium compounds, preferable are compounds containing Fe. In the sodium secondary battery, the heat resistant porous layer is disposed on the negative electrode side, and, even when the nonaqueous electrolytic solution has been in a heated state in the vicinity of the interface between the positive electrode and the heat resistant porous layer, the elution of transition metal ions such as Fe ion can be suppressed, the complexation of transition metal ions such as Fe ion can be suppressed, and the cycle property of the sodium secondary battery, or the discharge capacity maintenance ratio where charge and discharge are repeated can be further enhanced. In addition, the use of compounds containing Fe is extremely important from the standpoint of constituting secondary batteries by using a material that is abundant in resources and inexpensive.

When a negative electrode described later is composed mainly of a sodium metal or a sodium alloy, as the positive electrode active material, it is also possible to use chalcogen compounds such as sulfides capable of being doped and dedoped with sodium ions at potential higher than the negative electrode. Examples of the sulfides include compounds represented by M⁶S₂ such as TiS₂, ZrS₂, VS₂, V₂S₅, TaS₂; FeS₂, and NiS₂ (wherein M⁶ represents one or more transition metal elements). The exemplified positive electrode active materials facilitate operations of a secondary battery even in a sodium secondary battery in which the porous laminate film is not used as the separator.

Examples of the electrical conductive material include carbonaceous materials such as natural graphite, artificial graphite, cokes, and carbon black.

Examples of the binder include polymers of fluorine compounds. Examples of the fluorine compounds include fluorinated alkyl (having 1 to 18 carbon atoms) (meth)acrylate, perfluoroalkyl (meth)acrylate [for example, perfluorododecyl (meth) acrylate, perfluoro-n-octyl (meth)acrylate, perfluoro-n-butyl (meth)acrylate], perfluoroalkyl substituted alkyl (meth)acrylate [for example, perfluorohexyl ethyl (meth)acrylate, perfluorooctyl ethyl (meth)acrylate], perfluorooxyalkyl (meth)acrylate [for example, perfluorododecyloxyethyl (meth)acrylate, perfluorodecyloxyethyl (meth)acrylate], fluorinated alkyl (having 1 to 18 carbon atoms) crotonate, fluorinated alkyl (having 1 to 18 carbon atoms) malate and fumarate, fluorinated alkyl (having 1 to 18 carbon atoms) itaconate, fluorinated alkyl substituted olefin (having about 2 to 10 carbon atoms, having about 1 to 17 fluorine atoms), for example, perfluorohexylethylene; fluorinated olefin having about 2 to 10 carbon atoms and about 1 to 20 fluorine atoms in which a fluorine atom is connected to a double bond carbon; tetrafluoroethylene, trifluoroethylene, vinylidene fluoride or hexafluoropropylene and the like.

Other examples of the binder include addition polymers of monomers containing no fluorine atom and containing an ethylenic double bond. Examples of such monomers include (meth)acrylate monomers such as (cyclo)alkyl (having 1 to 22 carbon atoms) (meth)acrylate [for example, methyl (meth)acrylate, ethyl (meth)acrylate, n-butyl (meth)acrylate, iso-butyl (meth) acrylate, cyclohexyl (meth)acrylate, 2-ethylhexyl (meth)acrylate, isodecyl (meth)acrylate, lauryl (meth)acrylate, octadecyl (meth)acrylate]; aromatic ring-containing (meth)acrylate [for example, benzyl (meth)acrylate, phenylethyl (meth)acrylate]; mono(meth)acrylate of alkylene glycol or dialkylene glycol (alkylene group having 2 to 4 carbon atoms) [for example, 2-hydroxyethyl (meth)acrylate, 2-hydroxypropyl (meth)acrylate, diethylene glycol mono(meth)acrylate]; (poly)glycerin (polymerization degree: 1 to 4) mono(meth)acrylate; poly-functional (meth)acrylate [for example, (poly)ethylene glycol (polymerization degree: 1 to 100) di(meth)acrylate, (poly)propylene glycol (polymerization degree: 1 to 100) di(meth)acrylate, 2,2-bis(4-hydroxyethylphenyl)propane di(meth)acrylate, trimethylolpropane tri(meth)acrylate]; (meth) acrylamide monomers such as (meth)acrylamide, and (meth)acrylamide derivatives [for example, N-methylol(meth)acrylamide, diacetone acrylamide]; cyano group-containing monomers such as (meth)acrylonitrile, 2-cyanoethyl (meth)acrylate, and 2-cyanoethylacrylamide; styrene monomers such as styrene and styrene derivatives having 7 to 18 carbon atoms [for example, α-methylstyrene, vinyltoluene, p-hydroxystyrene, divinylbenzene]; diene monomers such as alkadiene having 4 to 12 carbon atoms [for example, butadiene, isoprene, and chloroprene]; alkenyl ester monomers such as carboxylic acid (having 2 to 12 carbon atoms) vinyl ester [for example, vinyl acetate, vinyl propionate, vinyl butyrate, vinyl octanoate], carboxylic acid (having 2 to 12 carbon atoms) (meth) allyl ester [for example, (meth) allyl acetate, (meth)allyl propionate, (meth)allyl octanoate], etc.; epoxy group-containing monomers such as glycidyl (meth)acrylate, and (meth)allyl glycidyl ether; monoolefins such as monoolefin having 2 to 12 carbon atoms [for example, ethylene, propylene, 1-butene, 1-octene, 1-dodecene]; monomers containing a halogen atom other than fluorine such as chlorine, bromine or iodine atom-containing monomers, vinyl chloride, and vinylidene chloride; (meth)acrylic acid such as acrylic acid, and methacrylic acid; and conjugated double bond-containing monomers such as butadiene, and isoprene.

The addition polymer may also be a copolymer such as an ethylene-vinyl acetate copolymer, styrene-butadiene copolymer, and ethylene-propylene copolymer. A vinyl carboxylate polymer may be partially or completely saponified like polyvinyl alcohol. The binder may also be a copolymer composed of a fluorine compound and a monomer containing no fluorine atom and containing an ethylenic double bond.

Other examples of the binder include polysaccharides such as starch, methylcellulose, carboxymethylcellulose, hydroxymethylcellulose, hydroxyethylcellulose, hydroxypropylcellulose, carboxymethylhydroxyethylcellulose, and nitrocellulose, and derivatives thereof; phenol resin; melamine resin; polyurethane resin; urea resin; polyamide resin; polyimide resin; polyamideimide resin; petroleum pitch; and coal pitch.

As the binder, polymers of fluorine compounds are particularly preferable, and polytetrafluoroethylene as a polymer of tetrafluoroethylene is especially preferable. In addition, as the binder, a plurality of types of the above-described binders may be used. When the binder thickens, a plasticizer may be used in order to facilitate application on the positive electrode current collector.

Examples of the solvent include aprotic polar solvents such as N-methyl-2-pyrrolidone, alcohols such as isopropyl alcohol, ethyl alcohol, and methyl alcohol, ethers such as propylene glycol dimethyl ether, ketones such as acetone, methyl ethyl ketone, and methyl isobutyl ketone.

The conductive adhesive is a mixture of an electric conductive material and a binder, and a mixture of carbon black and polyvinyl alcohol is particularly suitable since there is no need to use the solvent, preparation thereof is easy and, further, it is superior also in storage ability.

The blending amount of each constituent material in the positive electrode mixture may be appropriately set, the blending amount of the binder is usually about 0.5 to 30 parts by weight, and preferably about 2 to 30 parts by weight with respect to 100 parts by weight of the positive electrode active material, the blending amount of the electrical conductive material is usually about 1 to 50 parts by weight, and preferably about 1 to 30 parts by weight with respect to 100 parts by weight of the positive electrode active material, and the blending amount of the solvent is usually about 50 to 500 parts by weight, and preferably about 100 to 200 parts by weight with respect to 100 parts by weight of the positive electrode active material.

Examples of the positive electrode current collector include metals such as nickel, aluminum, titanium, copper, gold, silver, platinum, aluminum alloy, and stainless steel; those formed from a carbonaceous material, activated carbon fiber, nickel, aluminum, zinc, copper, tin, lead or an alloy thereof by plasma thermal spray or arc thermal spray; conductive films obtained by dispersing an electrical conductive material in a rubber or a resin such as a styrene-ethylene-butylene-styrene copolymer (SEES). Particularly, aluminum, nickel, or stainless steel is preferable, and aluminum is especially preferable because of its easiness in processing into a thin film and its low cost. Examples of the shape of the positive electrode current collector include foil, flat plate, mesh, net, lath, punching or emboss, and a combination thereof (for example, meshed flat plate). Irregularities may also be formed on the surface of the positive electrode current collector by an etching treatment.

### Negative Electrode

Examples of a negative electrode include an electrode in which a negative electrode mixture containing a negative electrode active material, a binder, and, if necessary, an electrical conductive material is supported on a negative electrode current collector, a sodium metal, and a sodium alloy, and the negative electrode is usually in the form of a sheet. More specifically, examples of a method of obtaining the negative electrode include a method in which a negative electrode mixture obtained by adding a solvent to a negative electrode active material, a binder and the like is coated on a negative electrode current collector by a doctor blade method, or immersion, and then dried, a method in which a solvent is added to a negative electrode active material, a binder and the like to yield a mixture, the mixture is kneaded, molded, and dried to yield a sheet, and the sheet is pressed and dried by a thermal treatment after being joined to the surface of a negative electrode current collector via a conductive adhesive or the like, and a method in which a mixture composed of a negative electrode active material, a binder, a liquid lubricant and the like is molded on a negative electrode current collector, the liquid lubricant is then removed, and the resultant sheet-shaped molded article is subjected to a drawing treatment toward a uniaxial or multiaxial direction. When the negative electrode is in the form of a sheet, the thickness thereof is usually about 5 to 500 μm.

The negative electrode active material, which can be used, includes a negative electrode material capable of being doped and dedoped with sodium ions. Examples of the negative electrode materials, which can be used, include carbonaceous materials such as natural graphite, artificial graphite, cokes, carbon black, pyrolytic carbons, carbon fiber, and organic polymer compound calcined bodies, the carbonaceous materials capable of being doped and dedoped with sodium ions. For enhancing the rate property of the sodium secondary battery, it is preferable to use a hardly graphitizable carbonaceous material. In particular, the combination of the hardly graphitizable carbonaceous material in the negative electrode and the nitrogen-containing aromatic polymer in the heat resistant porous layer is an excellent combination for enhancing the rate property of the sodium secondary battery. Examples of shapes of the carbonaceous materials include any of flake such as natural graphite, sphere such as mesocarbon microbeads, fiber such as graphitized carbon fiber, and aggregate of fine powder. It is possible to use the same binder and electrical conductive material as those used in the positive electrode. In the negative electrode, the carbonaceous material plays a role of the electrical conductive material in some cases.

When the positive electrode active material in the positive electrode is the above-described inorganic sodium compound, it is possible to use chalcogen compounds such as sulfides capable of being doped and dedoped with sodium ions at potential lower than the positive electrode. Examples of the sulfides include compounds represented by TiS₂, ZrS₂, VS₂, V₂S₅, TaS₂, FeS₂, NiS₂, and M⁶S₂ (wherein M⁶ represents one or more transition metal elements).

Examples of the negative electrode current collector include Cu, Ni, and stainless steel, and Cu is preferable in terms of difficulty in forming an alloy with sodium and easiness in processing into a thin film. Examples of the shape of the negative electrode current collector include foil, flat plate, mesh, net, lath, punching or emboss, and a combination thereof (for example, meshed flat plate). Irregularities may also be formed on the surface of the negative electrode current collector by an etching treatment.

### Nonaqueous Electrolytic Solution

A nonaqueous electrolytic solution is usually obtained by dissolving an electrolyte in an organic solvent. Examples of the electrolyte include NaClO₄, NaPF₆, NaAsF₆, NaSbF₆, NaBF₄, NaCF₃SO₃, NaN(SO₂CF₃)₂, lower aliphatic carboxylic acid sodium salts, and NaAlCl₄, and a mixture of two or more of these may also be used. Among these, it is preferable to use those containing fluorine, which include at least one selected from the group consisting of NaPF₆, NaAsF₆, NaSbF₆, NaBF₄, NaCF₃SO₃, and NaN(SO₂CF₃)₂.

Examples of the organic solvent include carbonates such as propylene carbonate, ethylene carbonate, dimethyl carbonate, diethyl carbonate, ethyl methyl carbonate, isopropyl methyl carbonate, vinylene carbonate, 4-trifluoromethyl-1,3-dioxolan-2-one, and 1,2-di(methoxycarbonyloxy)ethane; ethers such as 1,2-dimethoxyethane, 1,3-dimethoxypropane, pentafluoropropyl methyl ether, 2,2,3,3-tetrafluoropropyl difluoromethyl ether, tetrahydrofuran, and 2-methyltetrahydrofuran; esters such as methyl formate, methyl acetate, and γ-butyrolactone; nitriles such as acetonitrile, and butyronitrile; amides such as N,N-dimethylformamide, and N,N-dimethylacetamide; carbamates such as 3-methyl-2-oxazolidone; sulfur-containing compounds such as sulfolane, dimethyl sulfoxide, and 1,3-propane sultone; or compounds obtained by further introducing a fluorine substituent into the above-described organic solvents. As the organic solvent, two or more of these solvents may be used in admixture.

The concentration of the electrolyte is usually about 0.1 mol/L to 2 mol/L, and preferably about 0.3 mol/L to 1.5 mol/L.

### Method of Producing Sodium Secondary Battery

The sodium secondary battery can be produced by a method including steps (i), (ii), and (iii):

(i) The positive electrode, the separator, and the negative electrode are stacked in this order, and optionally wound to yield an electrode group,
(ii) the electrode group is accommodated in a vessel such as a battery can, and
(iii) the nonaqueous electrolytic solution is impregnated in the electrode group.

As described above, the separator is composed of the porous laminate film in which the heat resistant porous layer and the porous film are stacked each other. The separator is stacked so that the heat resistant porous layer may be disposed on the negative electrode side than the porous film.

Examples of the shape of the electrode group include a shape that gives a cross section of a circular shape, an elliptical shape, a rectangular shape, and a corner-rounded rectangular shape or the like, when the electrode group is cut in the direction perpendicular to the axis of winding thereof. Examples of the shape of the secondary battery include a paper shape, a coin shape, a cylinder shape, and an angular shape.

### EXAMPLES

Next, the present invention will be described in more detail by using examples.

### Production Example 1 (Production of Porous Laminate Film and Evaluation Thereof)

### (1) Production of Coating Liquid

Calcium chloride (272.7 g) was dissolved in NMP (4200 g), and para-phenylenediamine (132.9 g) was then added and completely dissolved. To the resultant solution, 243.3 g of terephthalic dichloride (hereinafter abbreviated as TPC) was gradually added, polymerization thereof was carried out to yield a para-aramide, and the solution was further diluted with NMP, whereby a para-aramide solution (A) having a concentration of 2.0% by weight was yielded. To 100 g of the yielded para-aramide solution, 2 g of an alumina powder (a) (manufactured by Nippon Aerosil Co., Ltd., Alumina C, average particle diameter: 0.02 μm (corresponding to D₂), particle shape: approximately spherical shape, particle aspect ratio: 1) and 2 g of an alumina powder (b) (Sumicorandom manufactured by Sumitomo Chemical Co., Ltd., AA03, average particle diameter: 0.3 μm (corresponding to D₁), particle shape: approximately spherical shape, particle aspect ratio: 1), as a filler in a total amount of 4 g, were added, these were mixed, treated three times by a nanomizer, further filtrated through a 1,000-mesh metal screen, and de-foamed under reduced pressure, whereby a slurry-form coating liquid (B) was produced. The weight of the alumina powders (filler) with respect to the total weight of the para-aramide and the alumina powders was 67% by weight. In addition, D₂/D₁ was 0.07.

### (2) Production of Porous Laminate Film

A polyethylene porous film (film thickness: 12 μm, air permeability: 140 sec/100 cc, average pore size: 0.1 μm, porosity: 50%) was used as a porous film. On a PET film having a thickness of 100 μm, the above-described polyethylene porous film was fixed, and the slurry-form coating liquid (B) was applied on the porous film by a bar coater manufactured by Tester Sangyo Co., Ltd. The applied porous film on the PET film was, while maintaining the integrity, immersed in water, which is a poor solvent, to precipitate a para-aramide porous layer (heat resistant porous layer), and the solvent was then dried to yield a porous laminate film 1 in which the heat resistant porous layer and the porous film were stacked each other. The thickness of the porous laminate film 1 was 16 μm, while the thickness of the para-aramide porous layer (heat resistant porous layer) was 4 μm. The porous laminate film 1 had an air permeability of 180 sec/100 cc, and a porosity of 50%. The cross section of the heat resistant porous layer in the porous laminate film 1 was observed by a scanning electron microscope (SEM) to find that relatively small micropores of about 0.03 μm to 0.06 μm and relatively large micropores of about 0.1 μm to 1 μm were present. As described above, the para-aramide as the nitrogen-containing aromatic polymer is used in the heat resistant porous layer of the porous laminate film 1, and the thermal film rupture temperature of the porous laminate film 1 was about 400° C. Evaluations of the porous laminate film were carried out by the following method.

### (3) Evaluation of Porous Laminate Film

### (A) Measurement of Thickness

The thickness of the porous laminate film and the thickness of the porous film were measured in accordance with JIS standard (K7130-1992). The thickness of the heat resistant porous layer was determined by subtracting the thickness of the porous film from the thickness of the porous laminate film.

### (B) Measurement of Air Permeability by Gurley Method

The air permeability of the porous laminate film was measured based on JIS P8117 by a digital-timer type Gurley densometer manufactured by Yasuda Seiki Seisakusho, Ltd.

### (C) Porosity

A sample of the obtained porous laminate film was cut into a square shape having a side length of 10 cm, and the weight W (g) and the thickness D (cm) thereof were measured. The weight (Wi (g)) of each layer in the sample was determined, the volume of each layer was determined from Wi and the true specific gravity (true specific gravity i (g/cm³)) of the material of each layer, and the porosity (% by volume) was determined according to the following formula:

Porosity (% by volume)=100×{1−(W1/true specific gravity 1+W2/true specific gravity 2+ . . . +Wn/true specific gravity n)/(10×10×D)}

### Production Example 2 (Production of Positive Electrode)

### (1) Synthesis of Positive Electrode Active Material

Sodium carbonate (Na₂CO₃: manufactured by Wako Pure Chemical Industries, Ltd.: purity 99.8%) and manganese oxide (IV) (MnO₂: manufactured by Kojundo Chemical Laboratory Co., Ltd.: purity 99.9%) as metal-containing compounds were weighed so as to have a Na:Mn molar ratio of 0.7:1.0, and mixed for 4 hours in a dry ball mill to yield a mixture of metal-containing compounds. The yielded mixture of metal-containing compounds was filled in an alumina boat, then heated in an air atmosphere by using an electric furnace and retained for 2 hours at 900° C. to yield a positive electrode active material 1.

### (2) Production of Positive Electrode

The positive electrode active material 1, acetylene black (manufactured by DENKI KAGAKU KOGYO KK) as an electrical conductive material, and PVDF (manufactured by KUREHA CORPORATION, PolyVinylidene DiFluoride Polyflon) as a binder were weighed so as to have a composition of positive electrode active material C1:electrical conductive material:binder=85:10:5 (ratio by weight). Thereafter, the positive electrode active material 1 and acetylene black were thoroughly mixed in an agate mortar, an adequate amount of N-methyl-2-pyrrolidone (NMP: Tokyo Chemical

Industry Co., Ltd.) was added to the mixture, PVDF was further added thereto, and these were continuously dispersed and kneaded so as to have uniformity, whereby a paste of an electrode mixture for the positive electrode was yielded. The paste was applied on a 40 μm-thick aluminum foil as a positive electrode current collector by using an applicator to a thickness of 100 μm of the paste, dried, and roll-pressed to yield a positive electrode sheet 1. The positive electrode sheet 1 was punched with a diameter of 1.5 cm by an electrode punching machine to yield a positive electrode 1.

### Production Example 3 (Production of Negative Electrode)

### (1) Synthesis of Negative Electrode Active Material

Into a four-necked flask, 200 g of resorcinol, 1.5 L of methyl alcohol, and 194 g of benzaldehyde were charged under nitrogen flow, followed by ice-cooling, and 36.8 g of 36% hydrochloric acid was added dropwise with stirring. After the completion of dropwise addition, the temperature was raised to 65° C., and then kept at the same temperature for 5 hours. To the resultant reaction mixture, 1 L of water was added, and the precipitate was collected by filtration, washed with water until the filtrate reached neutral, and then dried to yield 294 g of tetraphenyl calix [4] resorcinarene (PCRA). PCRA was put into a rotary kiln and heated at 300° C. for 1 hour with the atmosphere being set to an air atmosphere, further heated at 1000° C. for 4 hours with the atmosphere in the rotary kiln being replaced with argon, and then pulverized in a ball mill (agate-made ball, 28 rpm, 5 minutes) to yield a negative electrode active material 1 as a hardly graphitizable carbonaceous material. Since the negative electrode active material 1 as the powdery hardly graphitizable carbonaceous material is produced without contact with a metal material, the negative electrode active material 1 hardly contains a metal constituent.

### (2) Production of Negative Electrode

The negative electrode active material 1 as the hardly graphitizable carbonaceous material and polyvinylidene fluoride (PVDF) were weighed so as to have the composition of negative electrode active material 1:binder=95:5 (ratio by weight), and the binder was dissolved in N-methylpyrrolidone (NMP). Thereafter, the negative electrode active material 1 was added to this, and these were dispersed and kneaded so as to have uniformity, whereby a paste of an electrode mixture for the negative electrode was yielded. The paste was applied on a 10 μm-thick copper foil as a negative electrode current collector by using an applicator to a thickness of 100 μm of the paste, dried, and roll-pressed to yield a negative electrode sheet 1. The negative electrode sheet 1 was punched with a diameter of 1.5 cm by an electrode punching machine to yield a negative electrode 1.

### Production Example 4 (Production of Nonaqueous Electrolytic Solution)

### (1) Preparation of Nonaqueous Electrolytic Solution

With respect to 1 liter of propylene carbonate (PC) (C₄H₆O₃: manufactured by Kishida Chemical Co., Ltd., purity: 99.5%, water content: 30 ppm or less) as an organic solvent of a nonaqueous electrolytic solution, sodium perchlorate (NaClO₄: manufactured by Wako Pure Chemical Industries, Ltd.) as an electrolyte was weighed so as to be 1 mol (122 g) and added thereto, and stirred at room temperature for 6 hours, whereby a nonaqueous electrolytic solution 1 was yielded. Since the preparation was performed in a glove box of an argon atmosphere, the nonaqueous electrolytic solution 1 hardly contains water.

### Example 1 (Production of Sodium Secondary Battery of the Present Invention)

By using the porous laminate film in Production Example 1 as the separator, further using the positive electrode 1 in Production Example 2, the negative electrode 1 in Production Example 3, and the nonaqueous electrolytic solution 1 in Production Example 4, a sodium secondary battery 1 was produced such that the heat resistant porous layer in the porous laminate film is disposed on the negative electrode side. The positive electrode 1 in Production Example 2 was placed in a recess of the lower-side part of a coin cell (manufactured by Hohsen Corp.) by arranging the aluminum foil to face downward (arranging the positive electrode active material to face upward), the porous laminate film in Production Example 1 was placed thereon by arranging the heat resistant porous layer to face upward, and 0.5 milliliter of the nonaqueous electrolytic solution 1 in Production Example 4 was injected using a pipette. Further, by using metal sodium (manufactured by Aldrich Co.) as the negative electrode, the metal sodium was combined with an inner lid, they were placed on the upper side of the porous laminate film by arranging the metal sodium to face downward, covered with an upper-side part via a gasket, and caulked by a caulking machine, whereby the sodium secondary battery 1 was fabricated. The assembly of the test battery was carried out in a glove box under an argon atmosphere.

### (Evaluation Method of Property of Sodium Secondary Battery)

Using the fabricated sodium secondary battery 1, a constant current charge/discharge test was performed under the following conditions.

### Charge/Discharge Conditions:

The charge was performed by CC (constant current) charge at a 0.1 C rate (a rate at which complete charge was attained in 10 hours) up to 4.0 V. The discharge was performed by CC discharge at the same rate as the charging rate, and the current was cut off at a voltage of 1.5 V. Charge and discharge for the next and subsequent cycles were performed at the same rate as the charge rate, and the current was cut off at a charge voltage of 4.0 V and a discharge voltage of 1.5 V similarly to 1-st cycle. The charge and discharge were repeated 20 times.

### (Result of Evaluation of Property of Sodium Secondary Battery of the Present Invention)

As the result of evaluation of the discharge capacity of the sodium secondary battery 1 performed under the above-described conditions, it was found that the discharge capacity at 20-th cycle based on the discharge capacity at 2-nd cycle (discharge capacity maintenance ratio) was as high as 89%.

### Example 2 (Production of Sodium Secondary Battery of the Present Invention)

The same procedure as in Example 1 was performed to produce a sodium secondary battery 2 except that the negative electrode 1 in Production Example 3 was used as a negative electrode, the negative electrode 1 was combined with the inner lid such that the copper foil in the negative electrode 1 came in contact with the inner lid, and they were placed on the upper side of the porous laminate film by arranging the negative electrode active material to face downward.

### (Result of Evaluation of Property of Sodium Secondary Battery 2)

As the result of evaluation of the discharge capacity of the sodium secondary battery 2 performed under the same charge and discharge conditions as in Example 1, it was found that the discharge capacity at 20-th cycle based on the discharge capacity at 2-nd cycle (discharge capacity maintenance ratio) was as high as 102%.

### Comparative Example 1 (Production of Comparative Secondary Battery)

The same procedure as in Example 1 was performed to produce a comparative secondary battery except that a polyethylene porous film (film thickness: 12 μm, air permeability: 140 sec/100 cc, average pore size: 0.1 μm, porosity: 50%) was used as the separator.

### (Result of Evaluation of Property of Comparative Secondary Battery)

As the result of evaluation of the discharge capacity of the comparative secondary battery, it was found that the discharge capacity at 20-th cycle based on the discharge capacity at 2-nd cycle (discharge capacity maintenance ratio) was as low as 80%,

### INDUSTRIAL APPLICABILITY

According to the present invention, provided is a sodium secondary battery that is superior in heat resistance, also superior in secondary battery properties such as a discharge capacity maintenance ratio and the like, and further constituted of a material that is abundant in resources and inexpensive.

1. A sodium secondary battery comprising:
a positive electrode;
a negative electrode;
a separator disposed between the positive electrode and the negative electrode; and
a nonaqueous electrolytic solution, wherein
the separator is composed of a porous laminate film in which a heat resistant porous layer and a porous film are stacked each other, and the heat resistant porous layer is disposed on a negative electrode side.

2. The sodium secondary battery according to claim 1, wherein the heat resistant porous layer contains a heat resistant resin.

3. The sodium secondary battery according to claim 2, wherein the heat resistant resin is a nitrogen-containing aromatic polymer.

4. The sodium secondary battery according to claim 2, wherein the heat resistant resin is an aromatic polyamide.

5. The sodium secondary battery according to claim 2, wherein the heat resistant porous layer further contains a filler.

6. The sodium secondary battery according to claim 5, wherein an amount of the filler is 20 parts by weight or more and 95 parts by weight or less when a total weight of the heat resistant porous layer is assumed to be 100 parts by weight.

7. The sodium secondary battery according to claim 5, wherein the heat resistant porous layer contains two or more types of the fillers and, a ratio of D₂/D₁ is 0.15 or less where the largest average particle diameter is D₁ and the second largest average particle diameter is D₂ among average particle diameters each of which is determined by measuring constituent particles in each of the fillers.

8. The sodium secondary battery according to claim 1, wherein the thickness of the heat resistant porous layer is 1 μm or more and 10 μm or less.

9. The sodium secondary battery according to claim 1, wherein the negative electrode contains a carbonaceous material capable of being doped and dedoped with sodium ions.

10. The sodium secondary battery according to claim 9, wherein the carbonaceous material is a hardly graphitizable carbonaceous material.

11. The sodium secondary battery according to claim 1, wherein the porous film contains a polyolefin resin.
